(19) United States
(12) Patent Application Publication
(10) Pub. No.: US 2007/0153636 A1
(43) Pub. Date: Jul. 5, 2007

(54) Timepiece with AM/PM indicating

(76) Inventors: Wolfgang Burkhardt, Ispringen (DE); Gerhard Stotz, Eisingen (DE); Hans Schnell, Karlsbad-Langensteinbach (DE); Martin Dietrich, Neuenburg (DE); Ulrich Kalmbach, Pforzheim (DE); Michel G. Plancon, Besancon (FR)

Correspondence Address: Arthur G. Schaier;Carmody & Torrance LLP, P.O. Box 1110, 50 Leavenworth Street, Waterbury, CT, 06721-1110, US

(21) Appl. No.: 11/474,243

(22) Filed: Jun. 23, 2006

Related U.S. Application Data
(60) Provisional application No. 60/754,852, filed on Dec. 29, 2005.

(51) Int. Cl. G04B 19/24

(52) U.S. Cl. 368/28

(57) ABSTRACT

A wearable electronic device comprising a rotateable member for indicating the day of the week, wherein each day of the week is displayable with an AM indicator and a PM indicator, an actuation mechanism, operatively coupled to the rotateable member, for rotating the rotateable member in at least one of the clockwise and counterclockwise direction; and a controller, operatively coupled to the actuation mechanism, for causing the rotation of the rotateable member after at least essentially 12 hours so as to shift between indicating a day indicator with the AM indicator and (ii) the day indicator with the PM indicator. The rotateable member can be a day ring, merely an elongated member or a display hand. After essentially 12 hours the rotateable member again rotates so as to shift between displaying in the window (i) the day indicator with the PM indicator and (ii) a successive day indicator with the AM indicator. In a preferred embodiment, the wearable electronic device is a watch.

### RELATED APPLICATIONS

This application claims the benefit of U.S. Provisional Application No. 60/754,852, filed Dec. 29, 2005.

### BACKGROUND OF THE INVENTION

The present invention relates generally to timepieces, such as wristwatches, and in particular, to novel constructions and methodologies for indicating morning (e.g. “AM”) and afternoon (e.g. “PM”).

At least several ideas and constructions exist in the prior art for indicating whether the time is prior to noon (e.g. morning) or after noon (e.g. afternoon/evening). For example, in digital watches, the LCD may reserve display space for an “AM” or “PM” indicator. Use of display hands for indicating “AM” or “PM” are also known, but typically require its own display hand and gearing mechanism (e.g. stepping motor and gearing assembly).

The present inventors believe that improvements and advancements in the state of the art of indicating “AM” and “PM” in an analog type watch are achievable.

Accordingly, it is desirable to provide an electronic device, e.g. a timepiece/wristwatch with an improved “AM” and “PM” indication construction that is more aesthetically pleasing, functionally easy to use and read, and improves the constructability of the device itself (e.g. easier and/or less expensive to manufacture) than that found in the prior art, especially when implemented in an “analog type” watch. Other objectives of the present invention are set forth below.

### SUMMARY AND OBJECTIVES OF THE INVENTION

Accordingly, it is an objective of the present invention to provide an analog type timepiece with an improved “AM/PM” indicator and which overcomes the deficiencies in the prior art.

Specifically, it is an object of the present invention to provide an improved analog type timepiece comprising a date and/or day display with an “AM/PM” indicator that does not require substantial additional space on and/or in the dial.

Another object of the present invention to provide an improved “AM/PM” indication that does not require a separate motor or other actuation mechanism.

Another object of the present invention to provide an improved analog timepiece comprising an “AM/PM” indicator that is aesthetically pleasing and easy to read and adjust, if necessary.

Still another object of the present invention is to provide an easier and faster way to set the “AM” or “PM” indicator in a timepiece that displays such information, especially in an analog timepiece.

Yet another object of the present invention is to provide an improved timepiece comprising a date and/or day display that optimizes space constraints.

Still other objects and advantages of the invention will in part be obvious and will in part be apparent from the specification.

The invention accordingly comprises the features of construction, combination of elements, arrangement of parts and sequence of steps which will be exemplified in the construction, illustration and description hereinafter set forth, and the scope of the invention will be indicated in the claims.

Generally speaking, the present invention is directed to a wearable electronic device comprising a rotateable member for indicating the day of the week, wherein each day of the week is displayable with an AM indicator and a PM indicator, an actuation mechanism, operatively coupled to the rotateable member, for rotating the rotateable member in at least one of the clockwise and counterclockwise direction; and a controller, operatively coupled to the actuation mechanism, for causing the rotation of the rotateable member after at least essentially 12 hours so as to shift between indicating a day indicator with the AM indicator and (ii) the day indicator with the PM indicator. The rotateable member is preferably one of a day ring, merely an elongated member or a display hand. After essentially 12 hours the rotateable member again rotates so as to shift between displaying in the window (i) the day indicator with the PM indicator and (ii) a successive day indicator with the AM indicator. Other specifics of the present invention are provided hereinafter.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is a top plan view of a wearable electronic device constructed in accordance with a first embodiment of the present invention;

FIGS. 2A and 2B (collectively “FIG. 2”) are top plan views of the wearable electronic device of FIG. 1, with part of the dial being shown transparently so that details of a preferred gearing assembly (and rotation of the day ring) can be more easily illustrated and disclosed;

FIGS. 3A and 3B (collectively “FIG. 3”) are top plan views of a wearable electronic device constructed in accordance with a second embodiment of the present invention, again showing various positions of the display hand in accordance with the present invention;

FIG. 4 is a perspective view of a module for use in connection with the present invention;

FIG. 5 is a perspective view of a movement assembly in the module of FIG. 4 for a wearable electronic device constructed in accordance with the present invention;

FIG. 6 is a circuit diagram for an electronic device constructed in accordance with the present invention; and

FIG. 7 is a block diagram of a controller for use in an electronic device constructed in accordance with the present invention.

Identical reference numerals in the figures are intended to indicate like parts, although not every feature in every figure may be called out with a reference numeral.

### DETAILED DESCRIPTION OF THE PREFERRED EMBODIMENTS

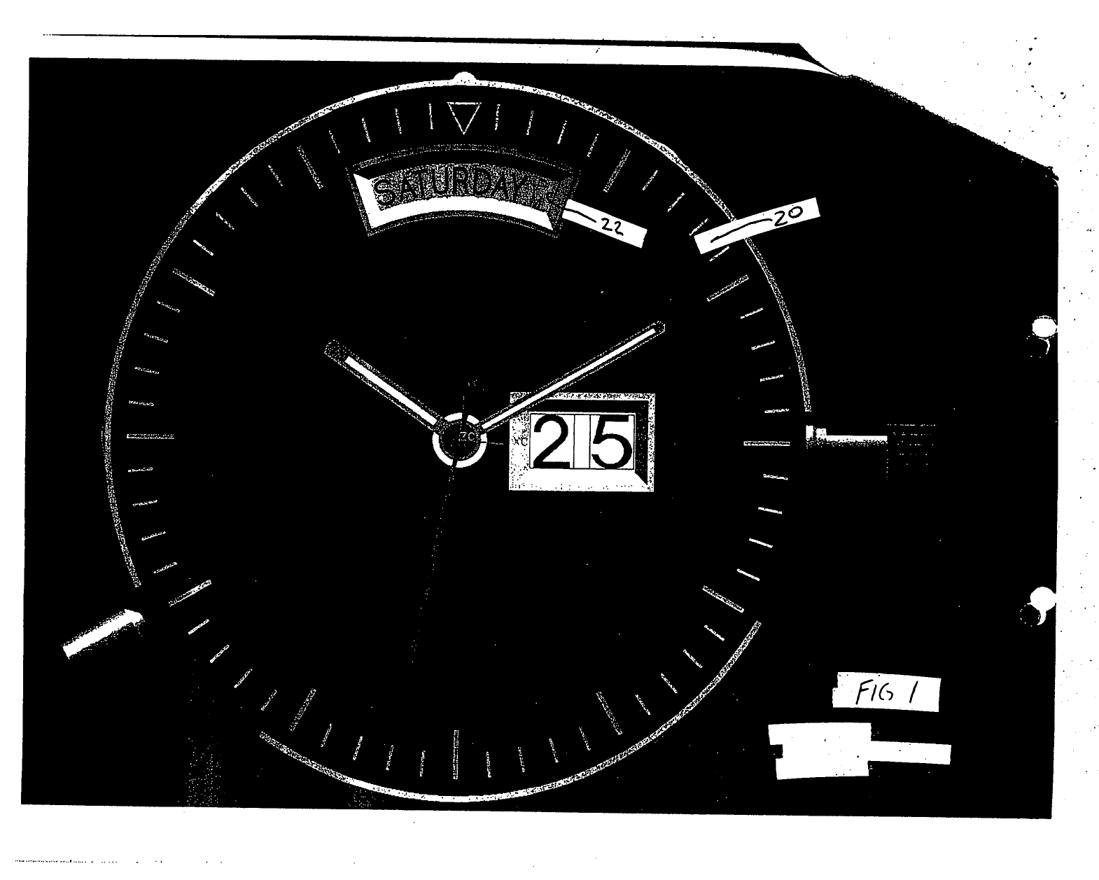

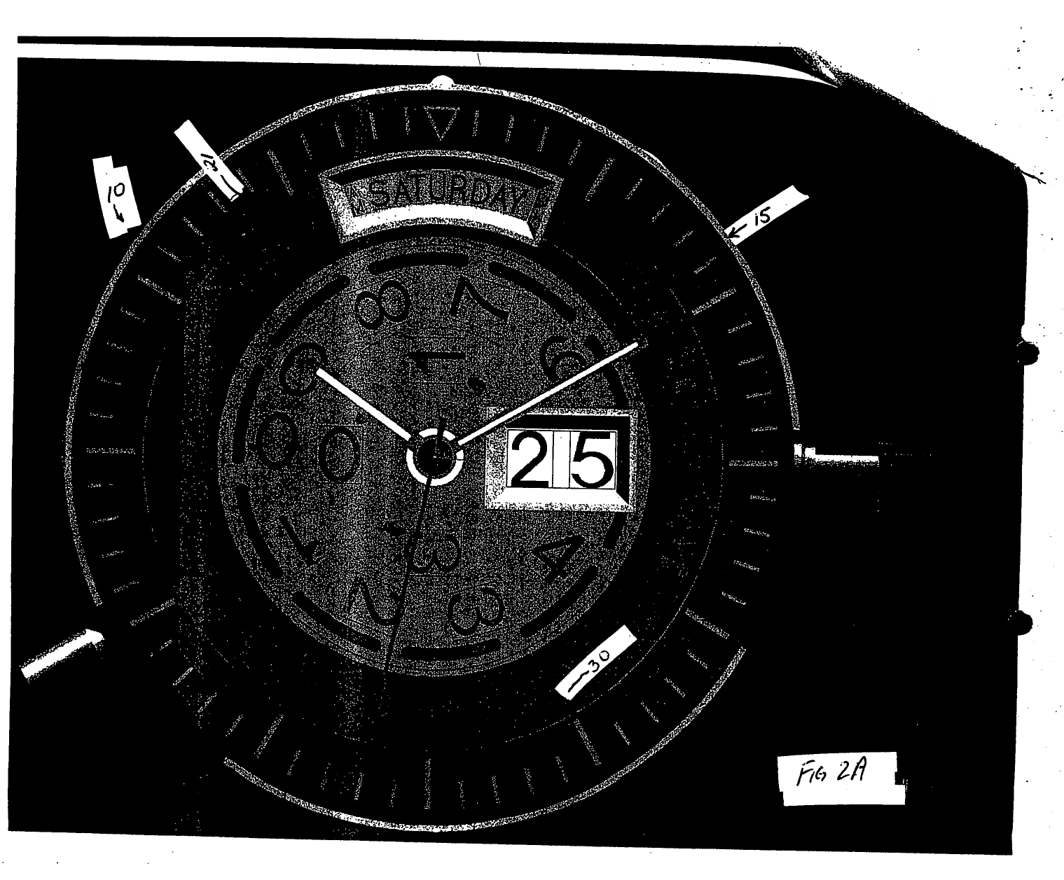

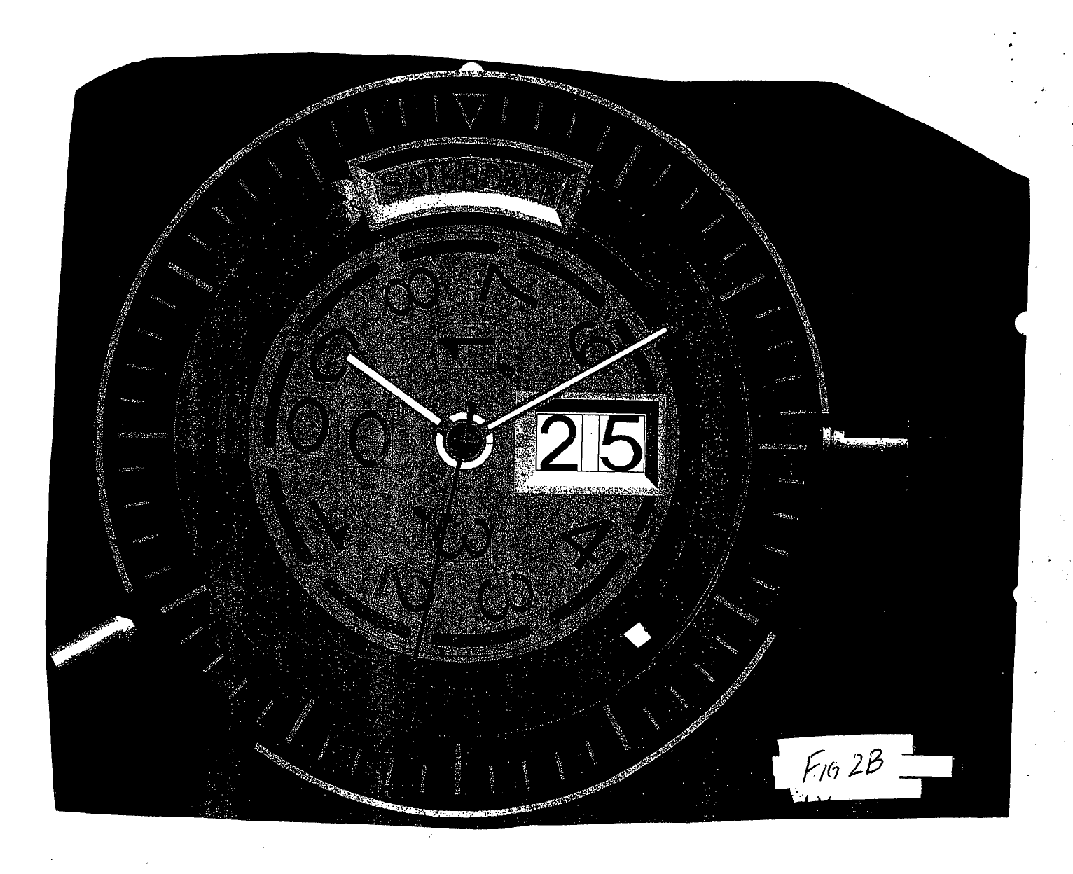

Reference shall first be made to FIGS. 1-2, wherein the relevant portions of a wearable electronic device, which in the preferred embodiment is a wristwatch, generally indicated at 10 and including features of a first embodiment of the present invention, is disclosed.

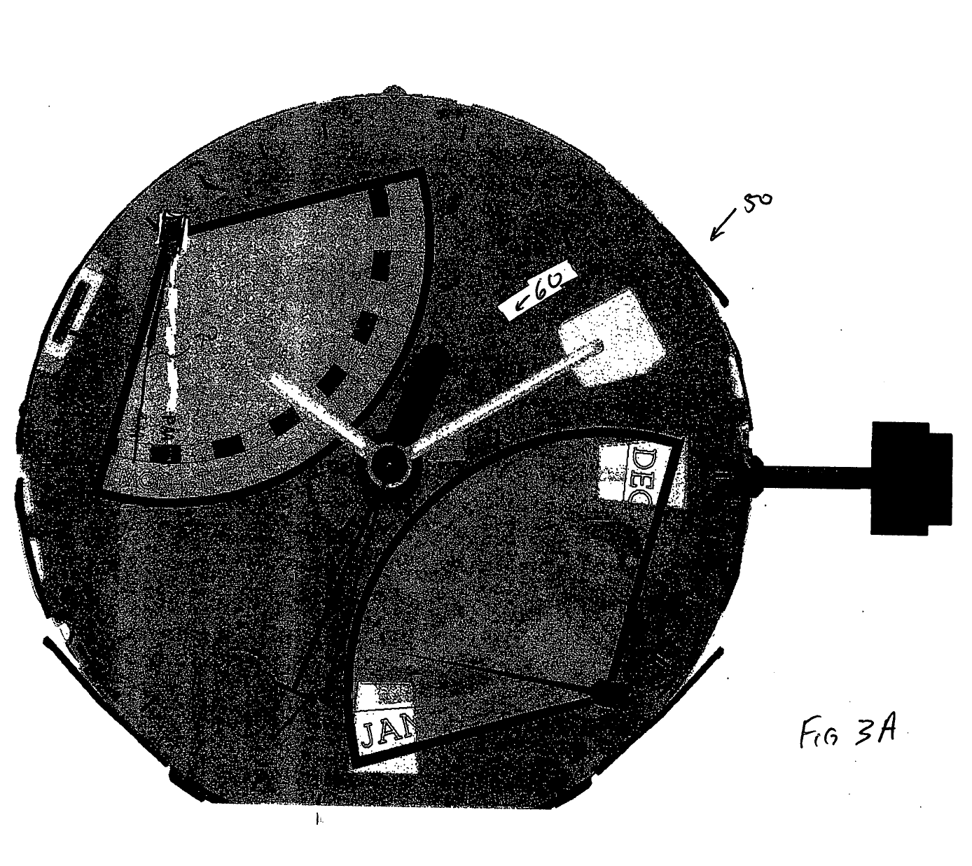

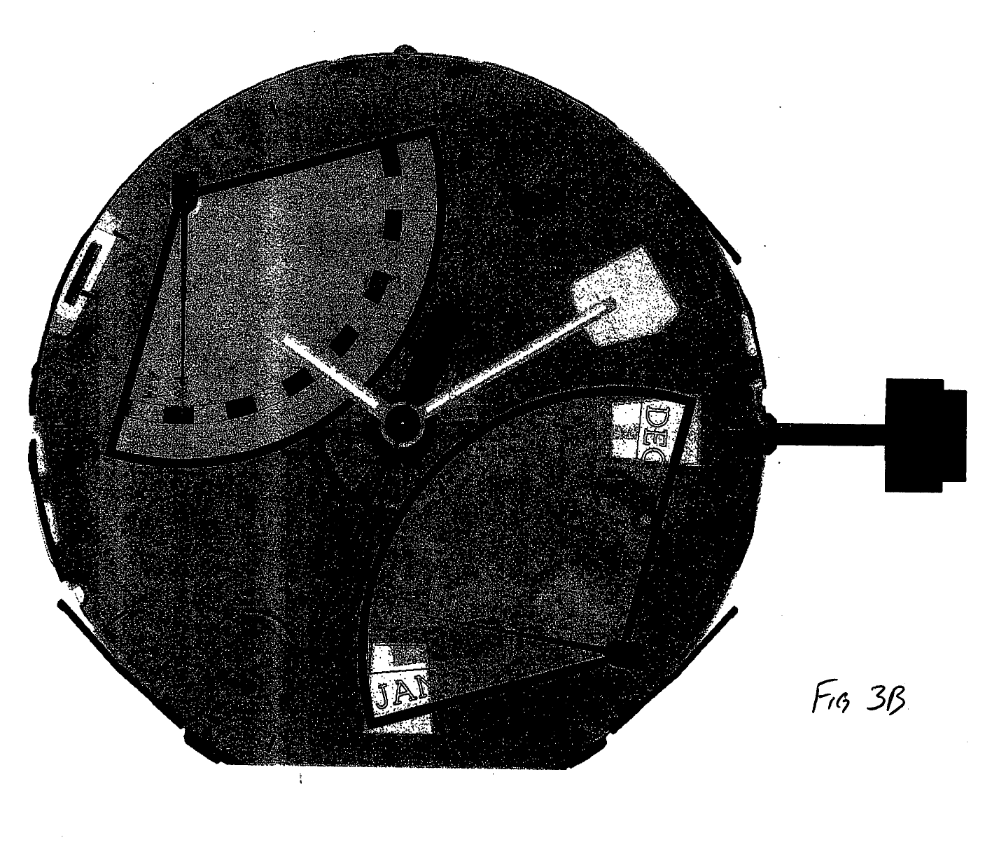

Device 10 comprises a module, generally indicated at 15, constructed in accordance with the present invention. In fact, a suitable module for use in the present invention and further details of the construction of such a module can be found in coowned and copending application Ser. Nos. 11/174,095 and 10//441,417, the subject matters of which are incorporated by reference as if fully set forth herein. In the preferred construction, module 15 is part of an electronic device, which is preferably a timepiece and a wristwatch in particular, having the configuration and construction as set forth in FIGS. 1-2 (a first exemplary embodiment) or in FIG. 3 (a second exemplary embodiment). Being a timepiece such as a wristwatch, device 10 may comprise other features and parts not material to the present invention and omitted herefrom for purposes of brevity.

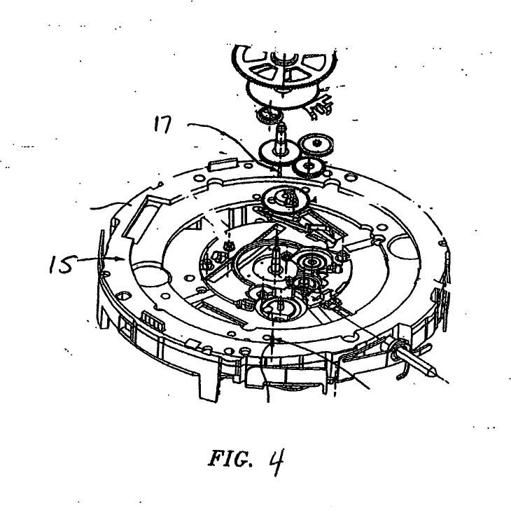

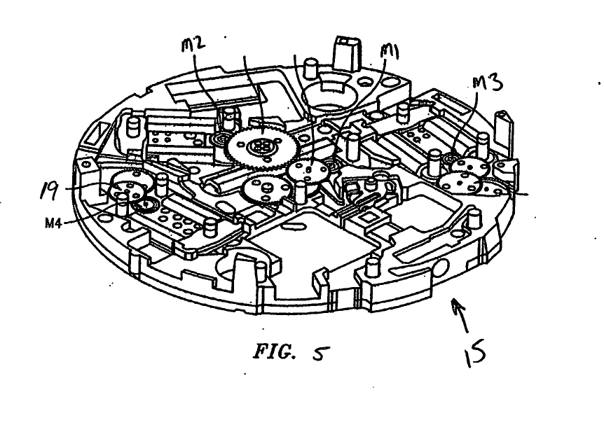

Reference is briefly made to FIGS. 4, 5 to disclose a movement assembly that can be used for both the device of the first embodiment and second embodiment of the present invention.

In a completed assembly and to carry out normal (e.g. hour/minute timekeeping and/or date) functionality, module 15 is provided with one or more subassemblies, each of which comprises at least one actuation mechanism and one or more gears rotateably engaged with the actuation mechanism, wherein actuation of the actuation mechanism causes the rotation of the one or more gears. The preferred actuation mechanisms are stepper motors designated generally in the figures as M1, M2, M3 and M4 all of which are disposed in module 15. As would be understood in the art, their specific location is one of design choice and dictated by constraints such as spacing, power and torque requirements.

As positioned in module 15 and relevant to the present invention, motor M4 is provided to rotate pinion 17, which itself may be part of an additional gear/wheel, and the rotation of the rotor of motor M4 imparts rotation of pinion 17 via a gear train, generally indicated at 19. The purpose of motors M1, M2 and M3 are not material to the present invention, although details thereof can be found in the aforementioned '441 application. With module 15 constructed as set forth, namely with pinion 17 extending from module 15, varying display assemblies can provided thereon. To the extent further details of varying constructions are desired, reference may specifically had to the '095 application.

Reference is again made to FIG. 1, wherein device 10 comprises a dial 20 having a window 22, through which at least one “AM/PM” indicator is visible. In this first embodiment, device 10 comprises a day ring 30 having a plurality of day indicators (e.g. “SUNDAY,” “MONDAY,” “TUESDAY,”. . . “SATURDAY”) thereon that indicate each of the days of the week. At least one of the day indicators (but preferably each of them) is positioned between an “AM” indicator and a “M” indicator.

This positioning of the day indicator between an “AM” and a “PM” indicator can take one of at least two configurations. For example, in a first configuration, each of the day indicators has associated therewith its own “AM” indicator and “PM” indicator. This configuration is illustrated most clearly in FIG. 2, which illustrates that each of the day indicators has on its “left” side an associated “AM” indictor and on its “right” side an associated “PM” indicator (such a configuration preferably has day ring 30 rotating counterclockwise, and a configuration whereby each of the day indicators have on its “right” side the associated “AM” indictor and on its “left” side its associated “PM” indicator preferably has day ring 30 rotating clockwise).

Alternatively, day ring 30 may have a configuration (although not shown) whereby instead of an “AM SUNDAY PM AM MONDAY PM AM TUESDAY PM AM WEDNESDAY PM . . . SATURDAY PM” display (i.e. FIG. 2), day ring 30 may have an “AM SUNDAY PM MONDAY AM TUESDAY PM WEDNESDAY . . . SATURDAY PM” configuration. Both configurations are intended to be covered hereby.

To rotate the day ring of this first embodiment, gearing assembly 19 comprises one or more wheels. Gearing assembly 19 is meshingly coupled to day ring 30 so that the rotation of the one or more wheels causes the rotation of the day ring. Specifically, pinion 17 is intended to be included in gearing assembly 19, and a gear 21 may be provided on pinion 17 and meshingly coupled to the day ring. Specifics of how a stepping motor may be operatively coupled to a gearing assembly and in turn coupled to day ring 30 may also be seen in coowned and copending application Ser. No. 11/221,031, the subject matter of which is also incorporated by reference as if fully set forth herein.

As such, actuation mechanism M4, rotateably coupled to the at least one or more wheels of gearing assembly 19, provides the rotation of day ring 30.

A controller 100, operatively coupled to actuation mechanism M4, is provided for causing the rotation of the day ring to rotate in a manner to be hereinafter disclosed.

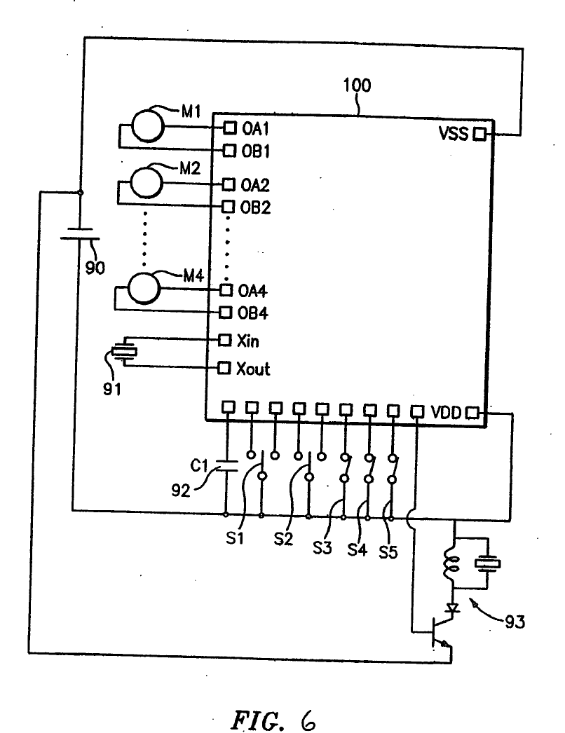

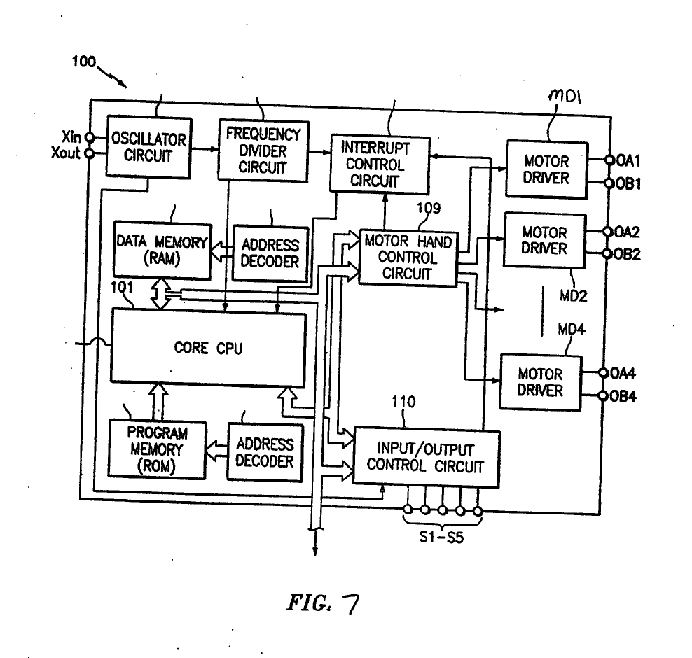

However, prior to disclosing the specific manner of rotation of day ring 30, reference is first generally made to FIGS. 6 and 7, which illustrates a controller to provide the proper and accurate controlling, positioning and rotation of day ring 30. It should also be understood that controller 100 similarly controls the use of the display hand to be implemented and disclosed in connection with the second embodiment of the present invention. Details of a generic controller for controlling either of the embodiments of the present invention can be found in the '441 application. The controller of the present invention preferably comprises all of the functional features described with respect to controller 100 in the aforementioned '417 application to carry out the objectives and features of the present invention. The functionality particular to the present invention shall now be disclosed.

FIGS. 6 and 7 illustrate among other things, interface connections to motors M1, M2, M3 and M4 and switches S1-S5. Switches S1-S5 are intended to generically indicate both side/top mounted pushers, as well as side mounted rotateable crowns, and thus respond to the actuation (i.e. pulling and/or pushing) action thereof. In the case of crowns, the pulling and or pushing actuations may be provided for setting and/or calibrating hands and/or day ring 30. Calibration, if any, permits controller 100 to “know” the position of day ring 30. An input/output control circuit 110 controls the crown actuations and pushbutton switches and provides such signaling information to CPU 101.

Particular reference is also made to motor control circuit 109, which receives a commanded “next number of pulses” from CPU core 101 and generates the pulsed and phased signals necessary to move a desired motor (e.g. M4) a desired amount and in a desired direction. Pulse outputs of motor control circuit 109 are buffered by motor drivers MD1, MD2, MD3, and MD4 and applied to respective motors M1, M2, M3, M4.

By appropriate configuration and programming of controller 100 it is thus possible to ensure that the functionality, operation and proper stepping (e.g. of stepping motor M4) is achieved. Also, those skilled in the art will know how to program controller 100 so that it may be customized or changed to properly control the particular display indicator (e.g. a day ring or a display hand).

Although the preferred embodiment provides that controller 100 is highly integrated wherein all timing and display functionality is controlled in controller 100, alternate embodiments could separate the timekeeping functions from other processing functions, as would be understood by one skilled in the art.

Lastly, signaling to controller 100 when it is time to rotate day ring 30 may be achieved by a gearing interface between the hour/minute wheels (e.g. incorporating the ideas and embodiments as set forth in coowned and copending U.S. application Ser. No. 10/342,512) or in accordance with an embodiment such as that disclosed in coowned and copending U.S. application Ser. No. 10/716,011; the subject matter of both of these '512 and '011 applications being incorporated by reference as if fully set forth herein.

Returning to FIGS. 1-2, it can now be seen that controller controls the rotation of day ring 30 so that after at least essentially 12 hours, day ring 30 rotates between displaying in the window (i) the day indicator with the “AM” indicator (i.e. as illustrated in FIG. 2A) and (ii) the day indicator with the “PM” indicator (i.e. as illustrated in FIG. 2B). Specifically, the example of FIGS. 2A and 2B illustrate how day ring 30 rotates between displaying in the window the “SATURDAY” day indicator with the “AM” indicator and the “SATURDAY” indicator with the “PM” indicator. Preferably, this rotation as set forth in the preceding sentences occurs at or about noon (i.e. 12:00 p.m.). In the preceding way, rotating between morning and afternoon requires the minimum amount of day ring rotation. The disclosure of application Ser. No. 10/716,011 also discloses how all of this can be microprocessor controlled.

In accordance with the present invention and with the day ring of FIGS. 2A and 2B, essentially 12 hour after the day ring has rotated so as to display a day indicator with the “PM” indicator, the day ring preferably rotates so as to shift between displaying in the window (i) the day indicator with the “PM” indicator and (ii) a successive day indicator with the “AM” indicator. For example, essentially 12 hours after rotation of day ring so as to display the “SATURDAY” and the “PM” indicator, day ring 30 again rotates between displaying in the window the “SATURDAY” day indicator with the “PM” indicator and the “SUNDAY” indicator with the “AM” indicator. Preferably, this latter rotation occurs at or about midnight (i.e. 12:00 a.m.). In the preceding way, rotating between evening and morning likewise requires the minimum amount of day ring rotation.

Again, alternatively, in the latter mentioned day ring configuration (i.e. AM SUNDAY PM MONDAY AM TUESDAY PM WEDNESDAY . . .“SATURDAY PM), controller 100 likewise causes the rotation of day ring 30 such that essentially 12 hour after the day ring has rotated so as to display a day indicator with the PM indicator, the day ring rotates so as to shift between displaying in the window (i) the day indicator with the PM indicator and (ii) a successive day indicator with an “AM” indicator. However, in this specific embodiment whereby the day indicators are merely positioned between an “AM” and “PM” indicator (as opposed to having its own associated “AM” and “PM” indicator), more rotation of day ring 30 is required when rotating from midnight on one day to morning on a successive day. Therefore, the specific embodiment illustrated in FIGS. 2A and 2B is preferred, although the embodiments of both specific implementations are covered by the present claims.

Reference is now made to FIGS. 3A and 3B which illustrates a wearable electronic device 50 in accordance with a second embodiment of the present invention. In this second embodiment, the device likewise comprises a dial 60 having a dial side and an actuation mechanism side, on the dial side there being provide a plurality of day indicators (“SUNDAY,” “MONDAY,”“TUESDAY,” . . . “SATURDAY”) wherein each of the day indicators has associated therewith an “AM” indicator and a “PM” indicator. However, and unlike the first embodiment which utilized a day ring, this second embodiment utilizes a display hand 70, positioned on the dial side and rotateable about an axis in at least one of a clockwise and counterclockwise direction. Hereto, an actuation mechanism, preferably in the form of a stepping motor (such as motor M4), is operatively coupled to display hand 70, for rotating display hand 70 in at least one of the clockwise and counterclockwise direction. Again, reference may be had to the aforementioned disclosures for details not material to the present invention but which may further educate the reader. And, for the reasons noted above, controller 100 can likewise be incorporated into this second embodiment and operatively coupled to the actuation mechanism, for causing the rotation of the display hand to rotate in at least one of a counterclockwise and clockwise direction. Again, application Ser. No. 11/174,095 discloses how module 15 can be implemented with both embodiments herein.

Being properly programmed and using known techniques, controller 100 can be properly designed to step motor M4 in the proper direction and amount so after at least essentially 12 hours (e.g. at or about noontime) display hand 70 is rotated between indicating a day indicator with the “AM” indicator (i.e. as illustrated in FIG. 3A) and (ii) the day indicator with the “PM” indicator (i.e. as illustrated in FIG. 3B). Specifically, the example of FIGS. 3A and 3B illustrate how display hand 70 rotates between indicating the “MONDAY” day indicator with the “AM” indicator and the “MONDAY” indicator with the “PM” indicator. Preferably, this rotation of the display hand as set forth in the preceding sentences occurs at or about noon (i.e. 12:00 p.m.).

Likewise, essentially about 12 hour after display hand 70 has rotated so as to indicate a day indicator with the “PM” indicator, display hand 70 rotates so as to shift between displaying in the window (i) the day indicator with the “PM” indicator and (ii) a successive day indicator with the “AM” indicator. For example, essentially 12 hours after rotation of display hand 70 so as to display the “MONDAY” and the “PM” indicator, display hand 70 again rotates between indicating the “MONDAY” day indicator with the “PM” indicator and the “TUESDAY” indicator with the “AM” indicator. Similarly, this latter rotation occurs at or about midnight (i.e. 12:00 am.).

It should be understood that the present disclosure will omit, for purposes of brevity, certain basic and very well known concepts regarding such electronic devices, such as for example, the basic construction and arrangements of gears and/or gear trains to rotate a plurality of “standard” hands, such as an hour hand and a minute hand (as part of an analog watch), as being well within the purview of one skilled in the art, although reading the disclosures set forth above, greater detail can be easily found. Again, the construction of these respective gear trains are also well within the purview of one ordinarily skilled in the art.

In the preferred embodiment, motor M4 is a bi-directional stepper motor thus being able to rotate in either direction, and the construction of acceptable stepper motors to functionally operate in this manner are widely available and well within the understanding of those skilled in the art. Suitable dials are also well within the purview of the skilled artisan.

As should be appreciated by one skilled in the art, the location, position and/or size of the day ring and/or display hand are merely dictated, for example, by the position of pinion 17 and the position of the respective subassemblies and thus the illustrations herein are shown by example and not limitation.

The gearing ratio to provide for the desirable display rotation or movement of the display hands or discs/rings would be one of design choice depending on the desired or required incremental rotation of the display indicator, an example of which is provided in the '417 application. Thus the number of wheels in any particular gearing assembly may be more or less than that disclosed herein, and are really one of design choice for the intended function and based upon a number of criterions known to the ordinary designer.

Also, the functionality of the controller can be modified to accommodate the varying embodiments disclosed herein by software-programming techniques or differing controllers, both of which is well within the purview of the skilled artisan.

It will thus be seen that the present invention is both patentably different from and a significant improvement over known devices. Specifically, the present invention provides a unique way to provide an “AM and PM” indication on an electronic device, such as a wristwatch that displays information in an analog manner. For example, the present invention provides an improved “AM/PM” indicator which overcomes the deficiencies in the prior art, that does not require substantial additional space on and/or in the dial, does not require a separate motor or other actuation mechanism, that is aesthetically pleasing and easy to read and adjust, if necessary. Other objectives and advantages afforded by the present invention are set forth above.

While the invention has been particularly shown and described with respect to preferred embodiments thereof, it will be understood by those skilled in the art that changes in form and details may be made therein without departing from the scope and spirit of the invention. For example, in place of a day ring, an elongated member may be used with the controller recalibrating the position of the ring at the beginning of each week.

What is claimed is:

1. A wearable electronic device comprising a window in a dial through which at least one AM/PM indicator is visible, wherein the wearable electronic device comprises:
a day ring having a plurality of day indicators thereon that indicate each of the days of the week, and wherein at least one of the day indicators is positioned between an AM indicator and a PM indicator;
a gearing assembly comprising one or more wheels, being meshingly coupled to the day ring so that the rotation of the one or more wheels causes the rotation of the day ring;
an actuation mechanism, rotateably coupled to the at least one or more wheels of the gearing assembly, wherein the rotation of the actuation mechanism causes the day ring to rotate; and
a controller, operatively coupled to the actuation mechanism, for causing the rotation of the day ring to rotate after at least essentially 12 hours so as to shift between displaying in the window (i) the day indicator with the AM indicator and (ii) the day indicator with the PM indicator.

2. The wearable electronic device as claimed in claim 1, wherein each of the day indicators has associated therewith its own AM indicator and PM indicator, and wherein the controller causes the rotation of the day ring such that essentially 12 hour after the day ring has rotated so as to display a day indicator with the PM indicator, the day ring rotates so as to shift between displaying in the window (i) the day indicator with the PM indicator and (ii) a successive day indicator with the AM indicator.

3. The wearable electronic device as claimed in claim 1, wherein each of the day indicators is positioned between an AM indicator and a PM indicator, and wherein the controller causes the rotation of the day ring such that essentially 12 hour after the day ring has rotated so as to display a day indicator with the PM indicator, the day ring rotates so as to shift between displaying in the window (i) the day indicator with the PM indicator and (ii) a successive day indicator with an AM indicator.

4. The wearable electronic device as claimed in claim 1, wherein the wearable electronic device is a watch.

5. The wearable electronic device as claimed in claim 1, wherein the actuation mechanism comprises a stepper motor which itself comprises a rotor, the rotor being operatively coupled to the gearing assembly for rotating the day ring, so that the rotation of the one or more wheels causes the rotation of the day ring in at least one of a clockwise and counterclockwise direction.

6. A wearable electronic device comprising a dial having a dial side and an actuation mechanism side, on the dial side there being provide a plurality of day indicators, wherein each of the day indicators has associated therewith an AM indicator and a PM indicator, wherein the wearable electronic device comprises:
a display hand, positioned on the dial side and rotateable about an axis in at least one of a clockwise and counterclockwise direction;
an actuation mechanism, operatively coupled to the display hand, for rotating the display hand in at least one of the clockwise and counterclockwise direction;
a controller, operatively coupled to the actuation mechanism, for causing the rotation of the display hand to rotate after at least essentially 12 hours so as to shift between indicating a day indicator with the AM indicator and (ii) the day indicator with the PM indicator.

7. The wearable electronic device as claimed in claim 6, wherein the controller causes the rotation of the display hand such that essentially 12 hour after the display hand has rotated so as to indicate a day indicator with the PM indicator, the display hand rotates so as to shift between indicating (i) the day indicator with the PM indicator and (ii) a successive day indicator with the AM indicator.

8. The wearable electronic device as claimed in claim 6, wherein the wearable electronic device is a watch.

9. A wearable electronic device comprising:
a rotateable member for indicating the day of the week, wherein each day of the week is displayable with an AM indicator and a PM indicator,
an actuation mechanism, operatively coupled to the rotateable member, for rotating the rotateable member in at least one of the clockwise and counterclockwise direction;
a controller, operatively coupled to the actuation mechanism, for causing the rotation of the rotateable member after at least essentially 12 hours so as to shift between indicating (i) the day indicator with the AM indicator and (ii) the day indicator with the PM indicator.

10. The wearable electronic device as claimed in claim 9, wherein the controller causes the rotation of the rotateable member such that essentially 12 hour after the rotateable member has rotated so as to indicate the day indicator with the PM indicator, the rotateable member rotates so as to shift between indicating (i) the day indicator with the PM indicator and (ii) a successive day indicator with the AM indicator.

11. The wearable electronic device as claimed in claim 9, comprising:
a window through a dial through which at least one AM/PM indicator is visible;
wherein the rotateable member is a day ring having a plurality of day indicators thereon that indicate each of the days of the week, and wherein at least one of the day indicators is positioned between an AM indicator and a PM indicator;
a gearing assembly comprising one or more wheels, being meshingly coupled to the day ring so that the rotation of the one or more wheels causes the rotation of the day ring;
wherein the actuation mechanism is a stepping motor comprising a rotor, wherein the rotor of the stepping motor is rotateably coupled to the at least one or more wheels of the gearing assembly, wherein the rotation of the rotor causes the day ring to rotate.

12. The wearable electronic device as claimed in claim 9, comprising:
a window through a dial through which at least one AM/PM indicator is visible;
wherein the rotateable member is an elongated member having a plurality of day indicators thereon that indicate each of the days of the week, and wherein at least one of the day indicators is positioned between an AM indicator and a PM indicator;
a gearing assembly comprising one or more wheels, being meshingly coupled to the elongated member so that the rotation of the one or more wheels causes the rotation of the elongated member;
wherein the actuation mechanism is a stepping motor comprising a rotor, wherein the rotor of the stepping motor is rotateably coupled to the at least one or more wheels of the gearing assembly, wherein the rotation of the rotor causes the elongated member to rotate.

13. The wearable electronic device as claimed in claim 11, wherein each of the day indicators has associated therewith its own AM indicator and PM indicator, and wherein the controller causes the rotation of the day ring such that essentially 12 hour after the day ring has rotated so as to display a day indicator with the PM indicator, the day ring rotates so as to shift between displaying in the window (i) the day indicator with the PM indicator and (ii) a successive day indicator with the AM indicator.

14. The wearable electronic device as claimed in claim 11, wherein each of the day indicators is positioned between an AM indicator and a PM indicator, and wherein the controller causes the rotation of the day ring such that essentially 12 hour after the day ring has rotated so as to display a day indicator with the PM indicator, the day ring rotates so as to shift between displaying in the window (i) the day indicator with the PM indicator and (ii) a successive day indicator with an AM indicator.

15. The wearable electronic device as claimed in claim 11, wherein the wearable electronic device is a watch.

16. The wearable electronic device as claimed in claim 9, comprising:
a dial having a dial side and an actuation mechanism side, on the dial side there being provided a plurality of day indicators, wherein each of the day indicators has associated therewith an AM indicator and a PM indicator;
wherein the rotateable member is a display hand, positioned on the dial side and rotateable about an axis in at least one of a clockwise and counterclockwise direction; and
wherein the actuation mechanism is operatively coupled to the display hand for rotating the display hand in at least one of the clockwise and counterclockwise direction.

17. The wearable electronic device as claimed in claim 16, wherein the controller causes the rotation of the display hand such that essentially 12 hour after the display hand has rotated so as to indicate a day indicator with the PM indicator, the display hand rotates so as to shift between indicating (i) the day indicator with the PM indicator and (ii) a successive day indicator with the AM indicator.

18. The wearable electronic device as claimed in claim 16, wherein the wearable electronic device is a watch.

19. The wearable electronic device as claimed in claim 16, wherein the actuation mechanism comprises a stepper motor which itself comprises a rotor, the stepper motor being operatively coupled to a gearing assembly comprising one or more wheels for rotating the display hand, so that the rotation of the one or more wheels causes the rotation of the day display hand in at least one of a clockwise and counterclockwise direction in predefined increments.
